(19) United States
(12) Patent Application Publication
(10) Pub. No.: US 2011/0134976 A1
(43) Pub. Date: Jun. 9, 2011

(54) POWER LINE COMMUNICATION SYSTEM WITH DC POWER BUS

(75) Inventors: Marc FOSSION, LIGNY (BE); Thierry SARTENAER, TONGRINNE (BE)

(73) Assignee: THALES, NEUILLY-SUR-SEINE (FR)

(21) Appl. No.: 12/948,839

(22) Filed: Nov. 18, 2010

(30) Foreign Application Priority Data
Nov. 19, 2009 (EP) 09176548.7

(51) Int. Cl. H04B 1/38

(52) U.S. Cl. 375/222

(57) ABSTRACT

A power line communication system with DC power bus includes a power supply source, a capacitive smoothing means for smoothing the electrical voltage delivered by the source to the bus, at least one distribution box supplied by the bus and dedicated to at least one item of equipment, and an electrical current coupler of high-frequency data-carrying signals and a data modem, which are attached to the distribution box and to at least one supply line of an item of equipment.

### CROSS-REFERENCE TO RELATED APPLICATION

This application claims priority to foreign European patent application No. EP 09176548.7, filed on Nov. 19, 2009, the disclosure of which is incorporated by reference in its entirety.

### FIELD OF THE INVENTION

The invention pertains to a Power Line Communication system or PLC system with DC power bus. More particularly, the present invention is aimed particularly at PLC applications aboard satellites (space sector), launchers (aerospace sector), and aircraft (aeronautical sector), in which the weight and bulk engendered by the wiring onboard aircraft/spaceships represent a significant cost that needs to be limited as far as possible. PLC technology, which allows power and data to be made to coexist on the same harness, therefore represents a high potential for savings. However, the invention can also be applied to any type of terrestrial or naval vehicle, such as a boat, a train, an automobile, or a truck.

### BACKGROUND OF THE INVENTION

The term Power Line Communication or PLC refers to a technology allowing the transfer of digital information by passing through an electrical power distribution line. In particular, PLC technology is commonly used on the low-voltage terrestrial network (AC current at 50 Hz or 60 Hz). Hence, it constitutes an alternative to traditional cables and to Wi-Fi technology.

Power Line Communication was already used on the terrestrial network for low bit rate industrial or home automation applications. It is only since the turn of the century and the digital revolution that they have been used by the public at large.

Within the framework of terrestrial applications, the principle of Power Line Communication consists in superimposing on the conventional 50-Hz or 60-Hz electrical supply current, a higher-frequency low-energy signal. This second signal propagates on the electrical installation and may be received and decoded remotely.

Thus the PLC signal is received by any PLC receiver which is on the same electrical network.

Terrestrial PLC systems are traditionally ranked into two categories as a function of the bit rate offered. High bit rate PLC uses frequencies in the band of frequencies from 1.6 to 30 MHz (HF band ranging from 3 to 30 MHz), and low bit rate PLC uses frequencies in the band of frequencies from 9 to 150 kHz in Europe and from 150 to 450 kHz in the United States.

Both at high and at low bit rate, the communication is subject to noise and to attenuations. It is therefore necessary to implement redundancy, for example in the form of error-correcting codes. A coupler integrated at the input of the PLC receivers eliminates the low-frequency components before the signal processing. The modem transforms a stream of bits into an analogue signal for emission and conversely on reception, said modem includes the functions for adding redundancy and for reconstituting the original bit stream or error correction.

In a similar manner to PLC systems operating on the terrestrial network, some applications are seeing the light of day aboard all types of vehicles, such as automobiles, trucks, trains, boats, aircraft, or satellites. The principle remains identical: the cables initially intended for electrical power distribution aboard the vehicle are reused to transmit communication signals at higher frequency. Depending on the type of vehicle concerned, it is possible to use alternating current (AC) or direct current (DC) electrical power supplies.

FIG. 1 illustrates a conventional example of a satellite electrical power supply network architecture.

This architecture comprises a power conditioning unit PCU, which acts as a central node in the satellite's power supply system. The power conditioning unit PCU comprises a solar regulating assembly SR which interfaces with the solar sensor SS to regulate the DC voltage produced on the DC power bus DCPB. The power conditioning unit PCU also comprises a regulating assembly BR for the battery BAT which directs the recharging of the battery BAT and the discharging processes.

A capacitive smoothing module CSM for smoothing the electrical voltage delivered to the direct current power bus, or supply bus DCPB, is embodied in the power conditioning unit PCU so that the DC voltage on the DC power bus DCPB remains stable in the case of transient phases of high current induced by the variable payload behaviour. The DC voltage provided on the power bus DCPB can, for example, be equal to 28 V, 50 V or 100 V, depending on the type of satellite and its architecture.

A plurality of electrical distribution units or distribution boxes DBi are connected to the power conditioning unit PCU. Their role is to provide power, through a certain number of separate circuits for the various items of equipment EQTi, or payloads, situated in the neighbourhood of the distribution box DBi. The distribution box DBi provides for the protection of the individual circuits by fuses, as well as devices for monitoring electrical consumption.

From a distribution box DBi, power cables provide the DC voltage for remote items of equipment EQTi. Generally, the power cables consist of a pair of twisted copper wires. In certain cases, the power cables consist of only a single conductor, the current then returning via the chassis of the satellite. In small-size satellites, the power conditioning unit PCU and the distribution boxes DBi are grouped into one and the same item of equipment.

FIG. 1 a illustrates a conventional example of an aircraft electrical power supply network architecture, in this instance for an aircraft fitted with four engines M1, M2, M3, and M4.

Each of the engines M1, M2, M3, and M4 comprises an associated AC supply SUPP_AC1, SUPP_AC2, SUPP_AC3, and SUPP_AC4 which typically generates a supply at 400 Hz and 115 V on the AC primary supply bus.

The electrical power supply network comprises power conditioning units PCU1, PCU2, PCU3, and PCU4, and distribution boxes DB1 and DB2. All these elements are linked by high-speed data buses through which the commands are received and executed.

The primary AC supply power delivered by the AC supplies SUPP_AC1, SUPP_AC2, SUPP_AC3, and SUPP_AC4 is generally converted, by means of transformers and rectifiers. Three sorts of power bus ACPB, DCPB1 and DCPB2 link the power conditioning units PCU1, PCU2, PCU3, and PCU4, and the distribution boxes DB1 and DB2. ACPB represents an AC bus typically at 400 Hz and 115 V or 230 V. DCPB1 represents a DC power bus, typically 28 V, and DCPB2 represents a high-voltage, typically 270 V, DC power bus.

The electrical supply is distributed to the remote distribution boxes DB1 and DB2, located in proximity to the items of equipment or payloads EQT1, EQT2, EQT3, EQT4 and EQT5.

Redundancy is ensured by attaching each distribution box DB1, DB2 to each power conditioning unit PCU1, PCU2, PCU3, and PCU4.

The use of Power Line Communication technology makes it possible to avoid having two separate networks, one for supplying electrical power to the elements, and the other for data communications.

The use of Power Line Communication makes it possible to drastically limit the number of connectors and wires, thereby making it possible to substantially limit the weight and bulk of the harness, for example onboard an aircraft or satellite.

The document “IPONS, A NEW CONCEPT FOR INTEGRATED POWER AND DATA DISTRIBUTION ONBOARD SATELLITES” (Oliver Scholz, Michael Gotsmann, Klaus Dostert, Matthias Gollor) illustrates an embodiment of a common network for both electrical power supply and data communication for a satellite.

However, such an embodiment comprises filtering inductors (section 4, FIG. 4.1) which have significant weight and bulk.

### SUMMARY OF THE INVENTION

The present invention overcomes the abovementioned deficiencies, and provides a system with decreased weight and bulk.

According to one aspect of the invention, a Power Line Communication system with DC power bus includes a power supply source, a capacitive smoothing means for smoothing the electrical voltage delivered by said source to said bus, and at least one distribution box supplied by said bus and dedicated to at least one item of equipment.

The system also includes an electrical current coupler of high-frequency data-carrying signals and a data modem, which are attached to said distribution box and to at least one respective supply line of an item of equipment. Furthermore, the DC power bus is designed for operating in differential mode, and comprises an electrical voltage coupler of high-frequency data-carrying signals and a data modem, which are disposed on each supply line downstream of said electrical current coupler and upstream of said item of equipment.

In differential mode, one conductor transports the current in the outbound direction, and another conductor transports the current in the return direction.

The present invention makes it possible to drastically limit the weight and bulk of the items of equipment, by using one and the same network for power and for data, and without any filtering inductors.

According to one embodiment, the data modems are adapted for processing the data-carrying signals by modulation of the spectrum and/or of the instant of emission.

For example these processings implemented are chosen from among processings such as digital signal coding by orthogonal frequency division in the form of multiple sub-carriers such as OFDM for “Orthogonal Frequency Division Multiplexing”, or Time Division Multiplexing (TDM). These processings are, for example, described at the following URL addresses:

http://en.wikipedia.org/wiki/OFDM; and

http://en.wikipedia.org/wiki/Time-division_multiplexing.

Thus, the management of the problem of disturbance to transmission is improved. The information is thus preferably transmitted at instants and/or frequencies that are hardly affected by the disturbances.

According to one embodiment, the data modems are adapted for applying techniques of temporal and/or frequency diversity to the data-carrying signals.

The same signals are then transmitted at multiple instants and/or frequencies so as to maximize the chances of resisting the disturbances.

In one embodiment, the data modems are adapted for processing the data-carrying signals by applying an error-correcting code and/or an automatic retransmission to the data-carrying signals.

Thus, the management of the problem of disturbance to transmission is improved. These processings of error-correcting code and of automatic retransmission to the data-carrying signals, are for example, described at the following URL addresses:

http://en.wikipedia.org/wiki/Error-correcting_code; and

http://en.wikipedia.org/wiki/Automatic_repeat_request.

Furthermore, the data modems may be adapted for performing an adaptive processing of said processings of the data-carrying signals carried out by the data modem.

The quality of the transmission of the data signals is further improved by the adaptive processing which automatically selects the processing or processings that can be carried out by the data modem, so as to use that or those which are best adapted to the disturbances which occur. This type of supervision is, for example described at the following URL addresses:

http://en.wikipedia.org/wiki/Orthogonal_frequency-division_multiplexing#Adaptive_transmission; and

http://en.wikipedia.org/wiki/Adaptive_modulation.

According to one embodiment, a respective supply line of an item of equipment comprises an electrical current coupler of high-frequency data-carrying signals and a data modem, and an electrical voltage coupler of high-frequency data-carrying signals and a data modem.

In the case of a point-to-point link, in differential mode, between a distribution box and an item of equipment, the invention is particularly reliable, notably for a system embedded onboard an aircraft or a spaceship such as a satellite.

In one embodiment, said electrical voltage coupler comprises an electrical voltage transformer and one or two coupling capacitors forming a galvanic isolation between said attached modem and said supply line of said power bus.

The use of such a transformer allows galvanic isolation between the data modem and the power bus, in case of a problem with the two coupling capacitors. It also makes it possible to protect the modem in case of abrupt transient periods of current on the power bus.

According to one embodiment, said electrical current coupler is furnished with a primary circuit comprising two uninterrupted copper tracks.

The presence of solder welds which create spurious impedances is thus avoided, as is the use of windings (coils) which inevitably modify the impedance of the power bus.

In one embodiment, the system comprises another electrical current coupler in redundancy and a redundant data modem attached to said other electrical current coupler.

Thus, whether dealing with a point-multipoint link between a distribution box and several items of equipment, or a point-to-point link between the distribution box and an item of equipment, in the case of a fault with the electrical current coupler, the coupler mounted in redundancy takes over.

In one embodiment, said current coupler is furnished with several secondary windings adapted for measuring the direct current consumed on the primary circuit by a technique of ‘fluxgate’ type.

This measurement is performed with the aid of a technique of ‘fluxgate’ type. The ‘fluxgate’ technique consists in using a magnetic core exhibiting strong saturation. The direct current to be measured, injected into the primary circuit, creates a continuous magnetic flux in this core. A variable current, of well chosen shape, for example two sinusoids, is injected into a secondary winding. This variable current creates in the core a variable magnetic flux which is superimposed on the continuous magnetic flux engendered by the current to be measured. Another secondary winding is used to measure the shape of the flux variation engendered by the various currents injected into the other windings. By virtue of the non-linear characteristic of the core used, this shape depends on the level of direct current injected into the primary circuit, thereby indirectly allowing measurement of this current.

Through the use of the ‘fluxgate’ technique for measuring the direct current consumed on the primary circuit, it is possible to save space, since there is no need to provide another device dedicated to this function.

According to another aspect of the invention, there is also proposed an aircraft or a spaceship comprising a system such as described above.

In this instance, for such a system integrated into an aircraft or a spaceship, the presence of two power conductors between the distribution box DBi and the various items of equipment EQTi is required. The high-frequency PLC signals must indeed be coupled in differential mode on the power line. Except, in certain configurations of aircraft/spaceships, a single power conductor is sometimes used to link the items of equipment to the distribution box. In these systems, the return current travels through the chassis of the aircraft/spaceship, to which all the items of electrical equipment are linked. A variant of this configuration, already commonly used in practice to avoid copper cables of overly large cross section, and which will necessarily have to be used in order to be compatible with the PLC technique, consists in separating the single power cable into at least two cables of smaller cross section each transporting part of the power current. The return current continues to travel through the chassis, and the overall bulk is not modified seeing as one cable of cross section ‘S’ is replaced with two cables of cross section ‘S/2’. These two cables are then used in common mode for electrical power transport, and in differential mode for PLC data transport. The benefit of limiting the cross section of the cables in this way resides in the resulting decrease in rigidity, as well as in the possibility of sharing the pins of one and the same connector between power distribution and the distribution of weak communication signals: several pins are then assigned to power distribution, each pin thus receiving a current of reasonable amplitude. This configuration has existed for many years in the field of power distribution aboard satellites.

To use the PLC technique in this particular configuration, current coupling is required at each end of the power bus: indeed, the short circuiting of the two cables of cross section S/2 at the level of the final connector prevents the use of voltage coupling.

According to another aspect of the invention, there is also proposed a terrestrial or naval vehicle comprising a system such as described above.

### BRIEF DESCRIPTION OF THE DRAWINGS

The invention will be better understood on studying embodiments thereof described by way of wholly non-limiting examples and illustrated by the appended drawings in which:

FIG. 1 schematically illustrates a satellite with DC power bus, of the prior art;

FIG. 1a illustrates a conventional example of an aircraft electrical power supply network architecture;

FIG. 2 illustrates a point-to-multipoint system, according to one aspect of the invention;

FIG. 3 illustrates a point-to-point system, according to one aspect of the invention;

FIG. 3a illustrates a point-to-point system with redundancy, according to one aspect of the invention;

FIG. 3b illustrates a system with current coupling on each side of the bus, adapted to power buses with current return through the chassis, according to one aspect of the invention;

FIG. 4 illustrates a filter at the input of an item of equipment; and

FIG. 5 illustrates an embodiment in which an electrical current coupler is furnished with a primary circuit comprising two uninterrupted copper tracks.

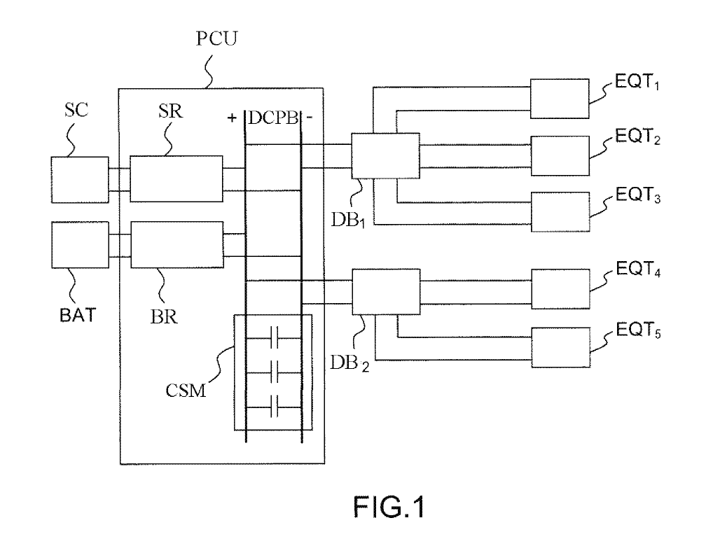

In the various figures, elements having identical references are identical.

### DETAILED DESCRIPTION

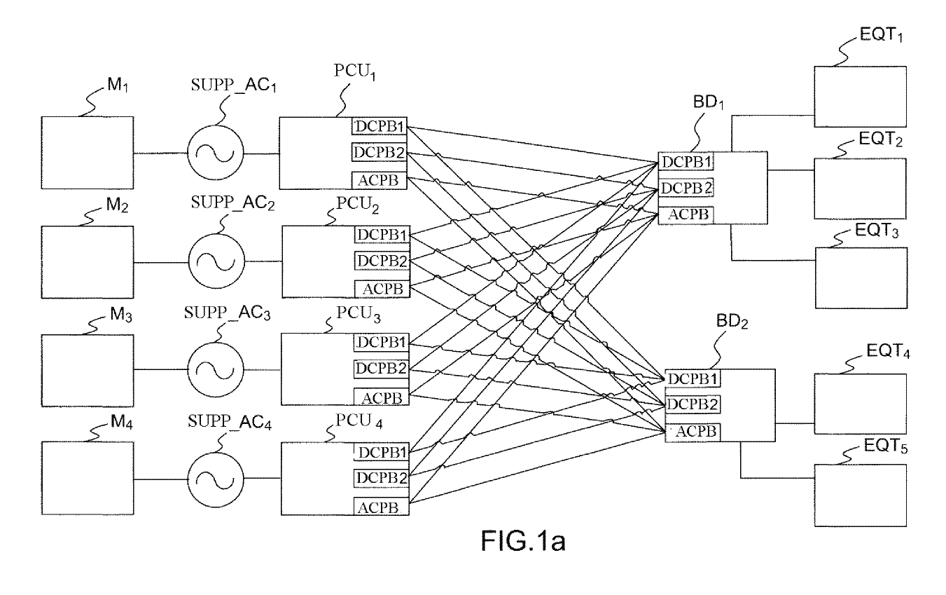

In FIG. 2 there is represented a Power Line Communication or PLC system with DC power bus DCPB. A capacitive smoothing module CSM for smoothing the electrical voltage delivered by a power supply source PSS, to the DC power bus DCPB. The capacitive smoothing module CSM, may, for example, comprise capacitors mounted in parallel. The DC power bus DCPB supplies a distribution box DB1. As a variant, the system may comprise a plurality of distribution boxes similar to the box DB1.

The distribution box DB1 supplies, through a common portion of supply line, comprising an electrical current coupler ECC of high-frequency data-carrying signals and a data modem MDM. In this example, the electrical current coupler ECC comprises a capacitor C and an inductor L.

At the output of the electrical current coupler ECC, two split supply lines supply respectively a first item of equipment EQT₁ and a second item of equipment EQT₂. The split supply line supplying the first item of equipment EQT₁ comprises, upstream of the first item of equipment EQT₁, an electrical voltage coupler EVC₁ of high-frequency data-carrying signals and a data modem MDM_{1b}. Likewise, the split supply line supplying the second item of equipment EQT₂ comprises, upstream of the second item of equipment EQT₂, an electrical voltage coupler EVC₂ of high-frequency data-carrying signals and a data modem MDM_{2b}.

The electrical voltage coupler EVC1 of high-frequency data-carrying signals comprises two respective capacitors C1b and C1c and an inductor L1b. Similarly, the electrical voltage coupler EVC2 of high-frequency data-carrying signals comprises two respective capacitors C2b and C2c and an inductor L2b.

There is therefore point-to-multipoint distribution.

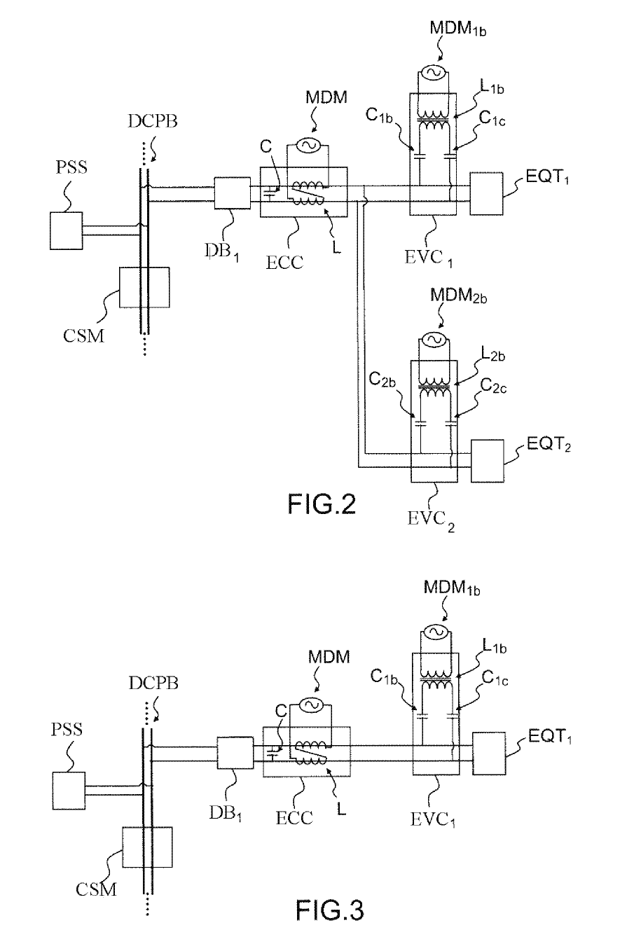

FIG. 3 illustrates another point-to-point embodiment between the supply box DB1 and the item of equipment EQT1. Of course this point-to-point link may be present in large number in a duplicated manner. Thus such a system is under point-to-point supply and communication, thereby limiting the risks of propagation of multiple faults.

FIG. 3a illustrates a variant of the point-to-point embodiment between the supply box DB1 and the item of equipment EQT1, for which variant the electrical current coupler ECCx2 is redundant in the sense that it comprises two coupling inductors L and L′, as well as two data modems MDM and MDM′. This redundant mode can naturally also be applied in the case of a point-to-multipoint embodiment.

FIG. 3b illustrates the system such as it must be implemented when using a DC power bus in common mode, with return of the direct current through the chassis CH. Between the connector CNT1 of the distribution box DB1 and the connector CNT2 of the item of equipment EQT1, which are represented in this figure, the conductor is separated into two strands ST1, ST2 of smaller cross section. The direct current Idc flows in the same direction within these two strands ST1, ST2, and then returns through the chassis CH. A data modem MDM and a current coupler ECC are used on the distribution box D₁ side. Another data modem MDM₃ and another current coupler ECC₃ (comprising an inductor L₃) are used on the side of the item of equipment EQT₁. In the case of a point-to-point link, in common mode, between a distribution box and an item of equipment, the invention is particularly reliable, notably for a system embedded aboard an aircraft or a spaceship such as a satellite. In common mode, at least two conductors transport the current in the outbound direction, the current in the return direction being transmitted by an element of the carrier of the Power Line Communication system, such as a conducting chassis for a satellite. The high-frequency data-carrying signals I_{ac} flow in differential mode on the two conductors, in that part of the circuit limited by the two connectors CNT₁, CNT₂. On output from the connector CNT₂, the two strands, or branches ST₁, ST₂, rejoin upstream of the item of equipment EQT₁.

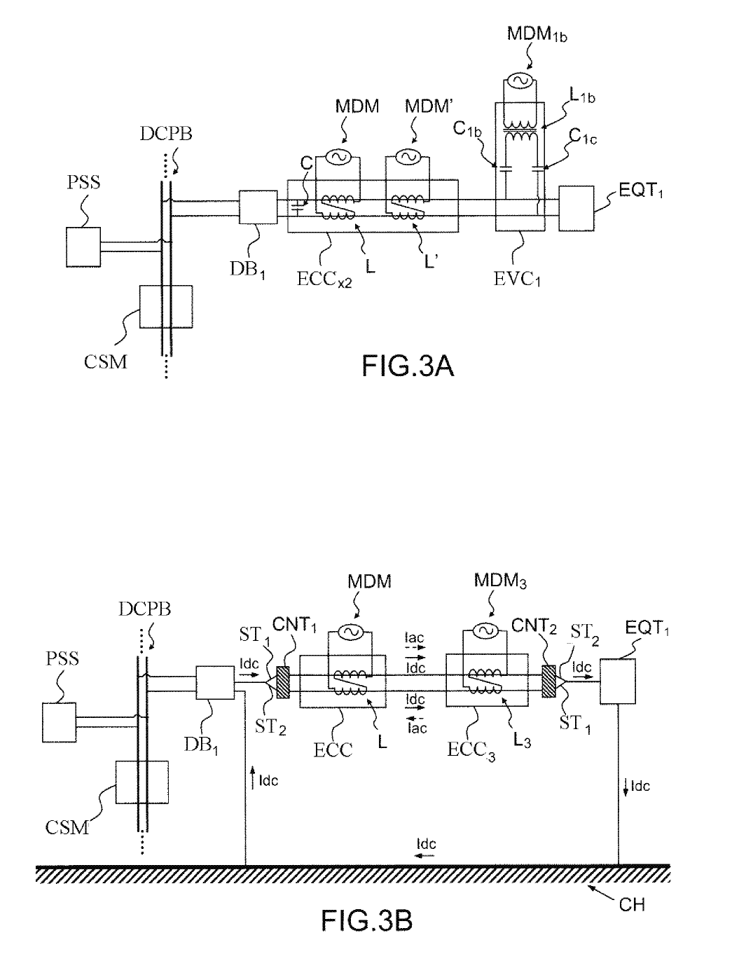

In the various items of equipment EQTi cited above, an input filter, such as represented in FIG. 4, is present to filter the high-frequency signals.

The inductor Lx and the capacitors Cx and Cy ensure the filtering in common mode, i.e. prevent the high-frequency signals generated in common mode on the supply buses DCPB from entering the item of equipment EQTi or payload, and vice versa. The inductor Ly and the capacitor Cz ensure the filtering in differential mode, i.e. they act as a low-pass filter for the high-frequency signals between the supply bus DCPB and the item of equipment EQTi.

The invention proposes an asymmetric coupling in the case of a power bus in differential, or a symmetric coupling in the case of a power bus in common mode, and a point-to-point advantageous embodiment. Indeed, in the point-to-point embodiment, the signals are isolated between the various lines of the items of equipment EQTi, thereby drastically limiting the reliability problems, since a problem in one item of equipment is decorrelated from the operation of the other items of equipment.

In the present invention, all the data modems MDM, MDM1b, MDM2b, and MDM3 may be adapted for processing the data-carrying signals by modulation of the spectrum and/or of the instant of emission.

For example these processings implemented may be chosen from among processings such as digital signal coding by orthogonal frequency division in the form of multiple sub-carriers such as OFDM, or such as time division multiplexing, TDM.

Thus, the management of the problem of disturbance to transmission is improved. The information is thus preferably transmitted at instants and/or frequencies that are hardly affected by the disturbances.

The data modems may be adapted for applying techniques of temporal and/or frequency diversity to the data-carrying signals. In this case, the same signals are transmitted at multiple instants and/or frequencies so as to maximize the chances of resisting the disturbances.

Furthermore, the data modems may be adapted for processing the data-carrying signals by application of an error-correcting code and/or by application of an automatic retransmission to the data-carrying signals.

Thus, the management of the problem of disturbance to transmission is improved.

Furthermore, the data modems may be adapted for performing an adaptive processing of said processings of the data-carrying signals carried out by the data modems.

The quality of the transmission of the data signals is further improved by the adaptive processing which automatically selects the processing or processings that can be carried out by the data modem, so as to use that or those which are best adapted to the disturbances which occur.

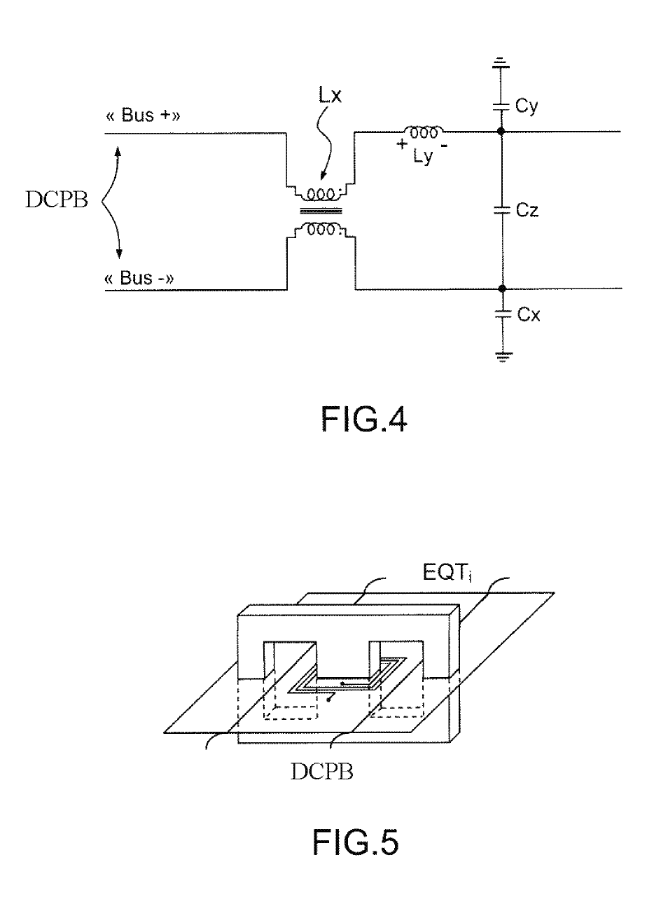

As illustrated in FIG. 5, the electrical current coupler ECC is furnished with a primary circuit comprising two uninterrupted copper tracks. This limits the presence of solder welds and windings, and associated spurious impedances. The electrical current coupler ECC is also furnished with a ferrite core around which is situated a secondary winding linked to the PLC modem.

The prior art vehicular power supply systems generally comprise a distribution box, wherein take place measurements of electrical current for monitoring the consumption of the load, and wherein is present a respective current-limiting fuse for an item of equipment so as to prevent a fault with an item of equipment from short-circuiting all or part of the system, notably in a satellite, a rocket or an aircraft.

In the present invention, the secondary winding of the electrical current coupler may be used to measure the primary current by using a technique of ‘fluxgate’ type, and thus the space occupied by the conventional measuring equipment for the distribution box may be recovered.

The volume used, and the resulting cost are thus limited, notably in the space and aeronautical sectors.

What is claimed is:

1. A power line communication system with DC power bus, comprising:
a power supply source;
a capacitive smoothing means for smoothing the electrical voltage delivered by said source to said bus; and
at least one distribution box supplied by said bus and dedicated to at least one item of equipment, wherein
the system further comprises an electrical current coupler of high-frequency data-carrying signals and a data modem, which are attached to said distribution box and to at least one respective supply line of said at least one item of equipment, and
the DC power bus is adapted for operating in differential mode, and comprises an electrical voltage coupler of high-frequency data-carrying signals and a data modem, which are disposed on each supply line downstream of said electrical current coupler and upstream of said at least one item of equipment.

2. The system according to claim 1, wherein the data modems are adapted for processing the data-carrying signals by modulation of the spectrum and/or of the instant of emission.

3. The system according to claim 1, wherein the data modems are adapted for applying techniques of temporal and/or frequency diversity to the data-carrying signals.

4. The system according to claim 1, wherein the data modems are adapted for processing the data-carrying signals by applying an error-correcting code and/or an automatic retransmission to the data-carrying signals.

5. The system according claim 2, wherein the data modems are adapted for performing an adaptive processing of said processing of the data-carrying signals carried out by the data modems.

6. The system according to claim 1, wherein a respective supply line of an item of equipment comprises an electrical current coupler of high-frequency data-carrying signals and a data modem, and an electrical voltage coupler of high-frequency data-carrying signals and a data modem.

7. The system according to claim 1, wherein said electrical voltage coupler comprises an electrical voltage transformer and one or two coupling capacitors forming a galvanic isolation between said attached modem and said supply line of said power bus.

8. The system according to claim 1, wherein said electrical current coupler is furnished with a primary circuit comprising two uninterrupted copper tracks.

9. The system according to claim 1, further comprising another electrical current coupler in redundancy and a redundant data modem attached to said other electrical current coupler.

10. The system according to claim 1, wherein said current coupler is furnished with secondary windings adapted for measuring the direct current consumed on the primary circuit by a technique of fluxgate type.

11. An aircraft comprising a system according to claim 1.

12. An spaceship comprising a system according to claim 1.

13. A terrestrial vehicle comprising a system according to claim 1.

14. A naval vehicle comprising a system according to claim 1.
